(19) United States
(12) Patent Application Publication
(10) Pub. No.: US 2016/0352281 A1
(43) Pub. Date: Dec. 1, 2016

(54) MOTOR DRIVING CIRCUIT

(71) Applicant: KABUSHIKI KAISHA TOSHIBA, Tokyo (JP)

(72) Inventors: Takeshi HINAGO, Yokosuka Kanagawa (JP); Katsunori SASAKI, Yokohama Kanagawa (JP); Hideki KIMURA, Yokohama Kanagawa (JP)

(21) Appl. No.: 15/060,763

(22) Filed: Mar. 4, 2016

(30) Foreign Application Priority Data
May 29, 2015 (JP) 2015-110195

(51) Int. Cl. H02P 29/68

(52) U.S. Cl. CPC H02P 29/68

(57) ABSTRACT

A motor driving circuit includes a frequency dividing circuit that outputs a divided clock signal obtained by dividing a reference clock signal, a temperature detecting element that detects a temperature in the motor driving circuit, a selecting circuit that receives the clock signals, and output one of the clock signals according to the temperature detected by the temperature detecting element, and a motor driving output unit that outputs a motor driving signal based on the selected clock signal. When the detected temperature is a predetermined temperature or more, the selecting circuit outputs the divided clock signal instead of the reference clock signal.

### CROSS-REFERENCE TO RELATED APPLICATION

This application is based upon and claims the benefit of priority from Japanese Patent Application No. 2015-110195; filed May 29, 2015, the entire contents of which are incorporated herein by reference.

### FIELD

Embodiment described herein relate to a motor driving circuit.

### BACKGROUND

Generally, a motor driving circuit generates heat when driving a motor. When the temperature of the motor driving circuit increases beyond a rated temperature, various components or circuit elements can be damaged, which may cause an unintended operation and/or destruction of the motor or motor driving circuit. Therefore, a temperature detecting element is provided in a motor driving output unit that is used to drive a motor. The temperature detecting element detects a temperature of the motor driving output unit or another component and stops the driving operation of the motor when the detected temperature is at or above the rated temperature. Thus, the motor may be suddenly stopped when the rated temperature is reached or exceeded, which adversely affects operations of the motor system. In order to restart the motor, it is necessary to stand by until the dissipation of the heat causing the temperature to rise above the rated temperature.

### DESCRIPTION OF THE DRAWINGS

FIG. 1 is a schematic view illustrating a structure of a motor driving circuit according to a first embodiment.

FIG. 2 is a waveform chart illustrating frequency of a clock signal and a current output by the motor driving circuit according to the first embodiment when at a rated temperature.

### DETAILED DESCRIPTION

Embodiments provide a motor driving circuit capable of continuously driving a motor.

In general, according to one embodiment, a motor driving circuit includes a motor driving output unit configured to output a motor driving signal to terminals connectable to a motor, a frequency dividing circuit configured to output a divided clock obtained by dividing a reference clock signal, a temperature detecting element configured to detect a temperature at or near the motor driving output unit and output a temperature signal according to the detected temperature, and a selecting circuit configured to receive the temperature signal and output one of the reference clock and the divided clock according to the temperature signal. When the detected temperature is a predetermined temperature or more, the selecting circuit outputs the divided clock signal.

Hereinafter, a first embodiment will be described with reference to the drawings. In the drawings, the same codes are attached to the same components and their detailed description is properly omitted.

### First Embodiment

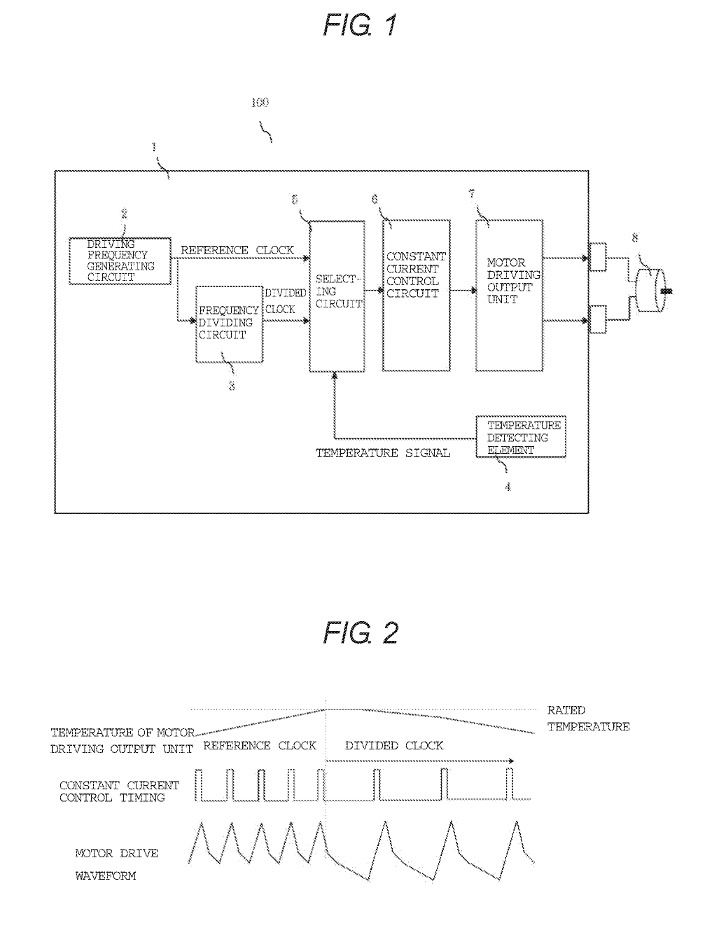

A motor driving circuit according to the first embodiment will be described with reference to FIGS. 1 and 2. FIG. 1 is a schematic view illustrating the structure of a motor driving circuit. FIG. 2 is a waveform chart illustrating the frequency of a clock signal and the current output by the motor driving circuit at the rated temperature.

In the motor driving circuit 100 according to the first embodiment, various elements are provided on a substrate 1. These elements include a driving frequency generating circuit 2, a frequency dividing circuit 3, a temperature detecting element 4, a selecting circuit 5, a constant current control circuit 6, and a motor driving output unit 7. A motor 8 operates according to a current output from the motor driving output unit 7. The elements of motor driving circuit 100 depicted as provided on the substrate 1 may be implemented substantially as an integrated circuit or substrate 1 may be, for example, a printed circuit board having different elements mounted thereon.

The driving frequency generating circuit 2 is formed by, for example, crystal oscillator and works to generate a reference clock of a constant frequency that is a reference signal of motor driving. The driving frequency generating circuit 2 is connected to the input terminal of the frequency dividing circuit 3 and the input terminal of the selecting circuit 5. The driving frequency generating circuit 2 supplies a reference clock signal to the frequency dividing circuit 3 and the selecting circuit 5.

The frequency dividing circuit 3 divides the reference clock signal (output from the driving frequency generating circuit 2) by a frequency division ratio n. The frequency division ratio n may be an integer multiple, for example, two (2) or three (3). The frequency dividing circuit 3 is connected to the input terminal of the selecting circuit 5. The frequency dividing circuit 3 outputs the divided clock signal (obtained by dividing the reference clock signal by frequency division ratio n) to the selecting circuit 5. The first embodiment will be described for an example with a frequency division ratio n of two (that is, n=2).

The temperature detecting element 4 is provided in the vicinity of, for example, the motor driving output unit 7. While detecting temperature changes in the motor driving output unit 7 (or an area proximate to motor driving output unit 7) caused by driving of the motor 8, the temperature detecting element 4 controls circuit components so as not to reach or exceed the rated temperature of the motor driving circuit 100. Here, the “rated temperature” is a temperature established according to expected durability of the final product in normal operations. The rated temperature may be set, for example, by reference to lifetime testing of individual components and/or full system testing, such as extended durability testing or stress testing. The “rated temperature” may also be based on estimated or simulated product lifetimes. In general, the “rated temperature” would typically be reported by a device manufacturer as a product specification, such as in a product manual or on technical specification sheet. The temperature detecting element 4 is connected to the selecting circuit 5 and supplies a temperature signal (corresponding to the detected temperature) to the selecting circuit 5 when the detected temperature reaches a predetermined value. The rated temperature depends on the specific components and the intended end-use of the motor driving circuit 100. For example, the rated temperature is between 100° C. and 150° C. When the rated temperature of the motor driving output unit 7 is 150° C., the temperature detecting element 4 is not directly contacting the motor driving output unit 7 or is otherwise subject to thermal resistance or other causes which might prevent the detected temperature of the temperature detecting element 4 from instantaneously matching the actual temperature of the motor diving output unit 7, the predetermined temperature used as a trigger may be less than the rated temperature, for example, 130° C. when the rated temperature is 150° C. The temperature detecting element 4 is preferably arranged near the motor driving output unit 7, which has a high heat generation amount as compared to other components in the system, so that various heat transfer considerations may be reduced, but the positioning of temperature detecting element 4 is not limited to any particular position.

The selecting circuit 5 selects and outputs one of the reference clock signal and the divided clock signal. The selecting circuit 5 is connected to the input terminal of the constant current control circuit 6. The reference clock signal and the divided clock signal output from the driving frequency generating circuit 2 are input to the selecting circuit 5. When a temperature signal (indicating a rated or a predetermined temperature corresponding to the rated temperature has been reached or exceeded) is output from the temperature detecting element 4, the selecting circuit 5 selects the divided clock and outputs to the constant current control circuit 6.

In the constant current control circuit 6, a current waveform is generated based on the one of the frequency of the reference clock or the divided clock signal which is output from the selecting circuit 5.

The motor driving output unit 7 generates a motor driving signal to drive the motor 8 according to the current waveform output from the constant current control circuit 6.

Next, the operation of the motor driving circuit according to the first embodiment will be described.

A reference clock signal of a predetermined frequency is supplied by a crystal oscillator included in the driving frequency generating circuit 2. The frequency dividing circuit 3 outputs a divided clock signal obtained by dividing the reference clock signal, for example, by two. Accordingly, the reference clock signal (output from the driving frequency generating circuit 2) and the divided clock signal (output from the frequency dividing circuit 3) are both input to the selecting circuit 5.

Here, the description will be made separately in the case where the detected temperature of the motor driving output unit 7 is less than the predetermined temperature and in the case where the detected temperature is at or above is the predetermined temperature.

The case where the temperature of the motor driving output unit 7 is less than the predetermined temperature is described first.

When the temperature of the motor driving output unit 7 is less than the predetermined temperature, the temperature detecting element 4 does not output the temperature signal (indicating the detected temperature is not at or greater than the predetermined signal) to the selecting circuit 5. Therefore, the selecting circuit 5 selects the reference clock signal and outputs the reference clock signal to the constant current control circuit 6. A signal corresponding to detected temperature may be constantly or intermittently output from the temperature detecting element 4, but the selecting circuit may be configured only to respond when the output signal (the temperature signal) indicates the detected temperature is at or above the predetermined temperature.

Upon receiving the reference clock signal, the constant current control circuit 6 raises or lowers the current value of the control signal to be output to the motor driving output unit 7 according to the frequency of the reference clock. The period of the rise and fall of the current value is determined based on the frequency of the signal received by the constant current control circuit 6. The current value repeatedly increases or decreases within a range of set current values.

After the current value drops to a certain value (low range current value), the current value increases again according to the reference clock. The period of the increase/decrease of the current value is determined depending on the frequency of the reference clock signal in this instance. The current waveform of the control signal supplied to motor driving output used as generated as illustrated in FIG. 2.

The current waveform output from the constant current control circuit 6 is input to the motor driving output unit 7. That is, the motor 8 rotates according to the current waveform supplied to the motor driving output unit 7.

Next, the case where the detected temperature of the motor driving output unit 7 is the predetermined temperature or more is described.

By driving the motor 8, the motor driving output unit 7 generates heat . When the temperature detecting element 4 detects the temperature increases to the predetermined value, the temperature detecting element 4 outputs the temperature signal (indicating the detected temperature is at or greater than the predetermined temperature) to the selecting circuit 5. According to this, the selecting circuit 5 selects the divided clock signal and outputs the divided clock signal to the constant current control circuit 6. The divided clock signal has a lower frequency than the reference clock signal. Therefore, in the current waveform output by the constant current control circuit 6, the period from a time when the output current increases to reach a set value to a time when a next output current increases is longer. In other words, the time between current peaks in the motor drive signal waveform is increased as an off period (low signal level) in the divided clock signal is longer than an off period (low signal level) of the reference clock signal. The percentage of one period in the motor drive signal waveform that the motor drive signal is active may be referred to as a duty cycle of the motor drive signal. Accordingly, it is possible to slow the heat generation of the motor driving output unit 7.

After the temperature detecting element 4 detects that the temperature is less than the predetermined temperature, the temperature signal is no longer output to the selecting circuit 5. According to this, the selecting circuit 5 then selects the reference clock signal and supplies it to the constant current control circuit 6. By outputting the reference clock signal, the output time of the current output from the motor driving output unit 7 is returned to the original state.

In the first embodiment, the frequency dividing circuit 3 is provided to frequency divide the reference clock signal to produce the divided clock signal. During the period in which the temperature of the motor driving output unit 7 is below the predetermined temperature, the selecting circuit 5 selects the reference clock signal and a drive current based on the reference clock signal is output to the motor 8. On the other hand, when the temperature reaches the predetermined value, the selecting circuit 5 selects the divided clock signal which has a frequency lower than that of the reference clock signal. By selecting the divided clock signal, the time between maxima in the drive current output to the motor 8 output is increased.

According to the above, the motor driving circuit 100 may be inhibited from reaching the rated temperature, and even when the rated temperature is reached, the motor driving may still be continuously performed without necessitating the stopping of the motor. Thus, system is not adversely affected by a sudden, unexpected stopping of the motor during operation. Further, since there is less need to provide the motor driving circuit a separate device (e.g., a radiator plate or a cooling system) for radiating or otherwise dispersing the generated heat in the motor driving circuit, the size and cost of the drive circuit may be reduced.

While certain embodiment has been described, the embodiment has been presented by way of example only, and is not intended to limit the scope of the intention. Indeed, the novel embodiment described herein may be embodied in a variety of other forms; furthermore, various omission, substitutions and changes in the form of the embodiment described herein may be made without departing from the spirit of the invention. The accompanying claims and their equivalents are intended to cover such forms or modifications as would fall within the scope and spirit of the invention.

What is claimed is:

1. A motor driving circuit, comprising:
a motor driving output unit configured to output a motor driving signal to terminals connectable to a motor;
a frequency dividing circuit configured to output a divided clock signal obtained by frequency dividing a reference clock signal;
a temperature detecting element configured to detect a temperature at or near the motor driving output unit and output a temperature signal according to the detected temperature; and
a selecting circuit configured to receive the temperature signal and output one of the reference clock signal and the divided clock signal according to the temperature signal, wherein
when the detected temperature is a predetermined temperature or more, the selecting circuit outputs the divided clock signal.

2. The motor driving circuit according to claim 1, wherein
when the detected temperature is less than the predetermined temperature, the selecting circuit outputs the reference clock signal.

3. The motor driving circuit according to claim 1, wherein
the predetermined temperature is set such that a temperature of the motor driving output unit does not exceed a rated temperature of the motor driving circuit.

4. The motor driving circuit according to claim 1, wherein the temperature detecting element is in direct contact with the motor driving output unit.

5. The motor driving circuit according to claim 1, wherein the temperature detecting element is not in direct contact with the motor driving output unit.

6. The motor driving circuit according to claim 1, wherein a frequency of the reference clock signal is an integer multiple of a frequency of the divided clock signal.

7. The motor driving circuit according to claim 6, wherein the frequency of the reference clock signal is twice the frequency of the divided clock signal.

8. The motor driving circuit according to claim 1, further comprising:
a constant current control circuit configured to generate a control signal waveform for controlling the motor driving output unit according to the one of the divided clock signal and the reference clock signal output by the selecting circuit.

9. The motor driving circuit according to claim 1, further comprising:
a crystal oscillator for generating the reference clock signal.

10. The motor driving circuit according to claim 1, wherein the motor driving output unit, the frequency dividing circuit, the temperature detecting element, and the selecting circuit are on a single substrate.

11. A motor driving circuit, comprising:
a motor driving output unit configured to output a motor driving signal to terminals connectable to a motor, the motor driving signal being based on a frequency of a control signal supplied to the motor driving output unit;
a frequency dividing circuit configured to output a divided clock signal obtained by frequency dividing a reference clock signal;
a temperature detecting element configured to detect a temperature of the motor driving circuit; and
a selecting circuit configured to receive a temperature signal output from the temperature detecting element and output one of the reference clock signal and the divided clock signal according to the temperature signal, wherein
when the detected temperature is at or above a predetermined temperature, a duty cycle of the motor driving signal is decreased as compared to a duty cycle of the motor driving signal when the detected temperature is below the predetermined temperature.

12. The motor driving circuit according to claim 11, wherein
when the detected temperature is less than the predetermined temperature, the selecting circuit outputs the reference clock signal.

13. The motor driving circuit according to claim 11, wherein the temperature of the motor driving circuit is a temperature of the motor driving output unit.

14. The motor driving circuit according to claim 11, wherein the predetermined temperature is set to a value that is less than a rated temperature of the motor driving circuit.

15. The motor driving circuit according to claim 11, wherein a frequency of the divided clock signal is a frequency of the reference clock signal divided by n, where n is an integer greater than 1.

16. The motor driving circuit according to claim 11, further comprising:
a constant current control circuit configured to generate a control signal waveform for controlling the motor driving output unit according to the one of the divided clock signal and the reference clock signal output by the selecting circuit.

17. The motor driving circuit according to claim 11, further comprising:
a crystal oscillator for generating the reference clock signal.

18. The motor driving circuit according to claim 11, wherein the temperature signal is output continuously from the temperature detecting element at a level that corresponds to a value of the detected temperature.

19. A method of controlling a motor, comprising:
establishing a reference clock signal;
establishing a divided clock signal by frequency dividing the reference clock signal, a frequency of the divided clock signal being less than a frequency of the reference clock signal;
detecting a temperature of a motor driving circuit with a temperature detecting element disposed in the motor driving circuit;
outputting one of the reference clock signal and the divided clock signal to a constant current control circuit in the motor driving circuit, the reference clock signal being output when the detected temperature is less than a predetermined temperature and the divided clock signal being output when the detected temperature is at or above the predetermined temperature; and
generating a control signal for driving a motor using the output one of the reference clock signal and the divided clock signal with the constant current control circuit, wherein a duty cycle of the control signal is decreased when the divided clock signal is used as compared to the when the reference clock signal is used.

20. The method of claim 19, further comprising:
supplying a drive current to the motor according to the control signal.
